(19) United States
(12) Patent Application Publication
(10) Pub. No.: US 2013/0305162 A1
(43) Pub. Date: Nov. 14, 2013

(54) MANUAL CLICKER APPLICATION

(71) Applicant: INNOVATION SOFTWARE, LLC, Cedar Falls, IA (US)

(72) Inventors: Chad Benson, Cedar Falls, IA (US); Mike Frost, Cedar Falls, IA (US)

(21) Appl. No.: 13/944,459

(22) Filed: Jul. 17, 2013

Related U.S. Application Data
(63) Continuation-in-part of application No. 13/656,225, filed on Oct. 19, 2012.

(51) Int. Cl. H04M 3/51

(52) U.S. Cl. CPC H04M 3/5158
USPC 715/739

(57) ABSTRACT

A method for manual intervention in a dialing process includes maintaining a list of records containing phone numbers in a database stored on a computer readable storage medium, receiving at a computer and from the user a click for each of the records within the list of records in the database stored on the computer readable storage medium, and storing on a computer readable storage medium a record of the click, an identity of the user performing the click, and an association between the click and one of the records within the list of records. For each click, the method provides for electronically communicating the corresponding phone number of one of the records within the list to a dialing device for dialing the phone number. The method may further include dialing the phone number using the dialing device.

### CROSS-REFERENCE TO RELATED APPLICATIONS

This application is a Continuation-in-part application of U.S. Ser. No. 13/656,225 filed Oct. 19, 2012, herein incorporated by reference in its entirety.

### FIELD OF THE INVENTION

The present invention relates to alternatives to using automatic or predictive dialers. More specifically, the present invention relates to a manual intervention process to allow users to manually perform clicking operations for records including phone numbers before the phone numbers are communicated to a dialing device.

### BACKGROUND OF THE INVENTION

Automatic and predictive dialers are widely used to increase efficiency of call center operations where outgoing phone calls are made on a large scale. Automatic dialers randomly or sequentially dial various numbers and detect when a live person answers the phone and then transfers the call to a human operator. Predictive dialers, while not necessarily random or sequential dialers, use various algorithms to reduce the amount of time that human operators spend waiting between calls transferred to them while also minimizing the occurrences of a live person answering the phone when no human operator is available.

In general, a call-system qualifies as “predictive” if that system dials, without human intervention, collections of phone numbers where the collection size varies continuously over time based on that system's internal decisions. The goal of a predictive dialer is to match an agent with one or more connects upon availability. That is to say, to predict how many consumers will answer the phone if N phone lines are dialed at time T (as a function of N and T) and then to select N and T so that when an agent becomes available he/she will have at least one available consumer to talk to after finishing his/her previous call. This is accomplished by tracking hits (someone answers the phone call) as a percentage of a certain number of previous attempts. By watching the hit rate through time, a predictive dialer is able to maintain a ratio of lines dialing per qualifying agent in order to successfully match up connected calls with available agents. It is impossible for a dialer to be predictive as it is understood in the industry without at least having BOTH of the following two features:
1. The ability to track hit rate through time and provide a prediction for what the hit rate of a current dial-out will be.
2. A dynamically updated matrix, algorithm or some other dynamic methodology for determining how many lines to dial at a given, specific point in time based on a number of agents, agent statuses and hit rate (other tracked statistics may be included in the calculation of the matrix but are not necessary for a dialing algorithm to be considered predictive).

Federal laws limit the use of automatic and predictive dialers in certain situations and place various requirements on their use. For example, the Telephone Consumer Protection Act (TCPA) regulations state that unauthorized cell phones may not be dialed via an Automated Telephone Dialing System (ATDS). What is needed is a way to allow for a manual intervention to be performed by human operators in an efficient manner which still allows some of the benefits of technology to be used.

### SUMMARY

Therefore, it is a primary object, feature, or advantage of the present invention to improve over the state of the art.

It is a further object, feature, or advantage of the present invention to provide for a dialing method and system which requires a manual intervention on the part of the human operator for each number which is dialed by a dialing device.

It is a still further object, feature, or advantage of the present invention to fully comply with applicable Telephone Consumer Protection Act (TCPA) regulations.

It is another object, feature, or advantage of the present invention to document when each phone number to be dialed is manually selected by a human operator.

Yet another object, feature, or advantage of the present invention is to provide a way for call centers who use dialing devices to comply with applicable regulations with a minimal disruption in their processes and systems.

A still further object, feature, or advantage of the present invention is to allow for a maximum number of clicks at a time to be set without the use of a predictive algorithm.

Another object, feature, or advantage of the present invention is to allow a dialing device to use different technologies based on whether the phone number is associated with unauthorized cell phone or a landline.

One or more of these and/or other objects, features, or advantages will become apparent from the specification and claims that follow. Note that no single embodiment need exhibit each and every object, feature, or advantage described herein as different embodiments may exhibit different objects, features, and advantages.

According to one aspect of the present invention, a method for manual intervention in a dialing process is provided. The method includes maintaining a list of records containing phone numbers in a database stored on a computer readable storage medium, receiving at a computer and from the user a click for each of the records within the list of records in the database stored on the computer readable storage medium, and storing on a computer readable storage medium a record of the click, an identity of the user performing the click, and an association between the click and one of the records within the list of records. For each click, the method provides for electronically communicating the corresponding phone number of one of the records within the list to a dialing device for dialing the phone number.

According to another aspect of the present invention, a method for providing a cloud-based service to provide for manual intervention in a dialing process is provided. The method includes maintaining a list of records containing unauthorized phone numbers in a database stored on a computer readable storage medium. The method further includes providing access to a manual clicker application through a server configured to access the database. The method further includes providing a user interface to a user of the manual clicker application, the user interface configured to receive clicks from a user. The method further includes receiving clicks from the user targeted at an icon of the user interface and storing within the database a record of each click from a user and associating each click from the user with one of the records and a corresponding unauthorized phone number. The method further includes electronically communicating each of the corresponding unauthorized phone numbers after storing the record of each click.

According to yet another aspect of the present invention, a method for manual intervention in a dialing process is provided. The method includes maintaining a list of records containing phone numbers in a database stored on a non-transitory computer readable storage medium, providing a user interface in operative communication with the database, wherein the user interface is configured to present a user with a target for clicking, receiving at a computer and from a user using the user interface, a click on the target for each of a plurality of individual records within the one or more lists of records in the database stored on the non-transitory computer readable storage medium. storing within the database and on the non-transitory computer readable storage medium a record of the click for each of the plurality of individual records, an identity of the user performing the click for each of the plurality of individual records, and an association between the click and a corresponding record for each of the plurality of records, and for each click electronically communicating the corresponding phone number of one of the records within the one or more lists to a dialing device for dialing the phone number. The user interface may provide for receiving multiple clicks and queuing each of the associated individual records for dialing. The number of clicks may be limited to a maximum clicks ahead constraint. The user interface may further provide for assigning a plurality of different access rights to different users. The access rights can include the right to add, modify, or delete the one or more lists or groups of lists. The access rights can further include the right to schedule one or more lists or groups of lists.

According to another aspect, a method for providing a cloud-based service to provide for manual intervention in a dialing process is provided. The method includes maintaining a list of records containing unauthorized phone numbers in a database stored on a non-transitory computer readable storage medium, providing access to a manual clicker application through a server configured to access the database, providing a user interface to a user of the manual clicker application, the user interface configured to receive clicks from a user, receiving a plurality of clicks from the user targeted at an icon of the user interface, storing within the database a record of each of the plurality of clicks from the user and associating each of the plurality of clicks from the user with one of the records and a corresponding unauthorized phone number, and electronically communicating to a dialing device each of the corresponding unauthorized phone numbers after storing the record of each click.

### BRIEF DESCRIPTION OF THE FIGURES

FIG. 1A illustrates one example of a system.

FIG. 1B is a block diagram illustrating a manual clicker app.

FIG. 2 illustrates a work flow of a user clicking

FIG. 3 illustrates another method.

FIG. 4 illustrates one example of a configuration or database schema for a relational database which may be stored on a computer readable storage medium.

FIG. 5A illustrates a login screen for a clicker application.

FIG. 5B illustrates a first time login screen.

FIG. 6 illustrates a screen display for a clicker application which allows a user to click once for each of the records within a list of records.

FIG. 7 illustrates another screen display for a clicker application where there are no phone numbers left in the list.

FIG. 8 illustrates a screen display showing a new user creation panel.

FIG. 9 illustrates a screen display showing a modify existing user panel.

FIG. 10 illustrates a screen display showing a reset password panel.

FIG. 11 illustrates another example of a screen display for a manual clicker application clicker page.

FIG. 12 illustrates one example of a screen display which may be displayed when certain conditions are present.

FIG. 13 illustrates one example of a set of buttons which includes a user maintenance button.

FIG. 14 illustrates a screen display for a user maintenance page.

FIG. 15 illustrates a screen display for a create new user page.

FIG. 16 illustrates a screen display for a modify an existing user page.

FIG. 17 illustrates a screen display for a reset a user password page.

FIG. 18 illustrates a screen display showing a schedule tab.

FIG. 19 illustrates a screen display showing an exception schedule tab.

FIG. 20 illustrates a list maintenance tab.

FIG. 21 illustrates a group maintenance tab.

FIG. 22 illustrates another example of a system.

### DETAILED DESCRIPTION

The present invention relates to a manual dial software application that may be used to provide a manual intervention in the dialing process. The manual dial software application may be a cloud-based software-as-a-service (SaaS) application. The manual dial application allows for a human being to enter unauthorized cell phone numbers into a list by clicking on an icon, the phone number or other user interface elements associated with a phone number. Once selected by the user through the clicking process, each of the cell phone numbers may then be dialed. The manual clicker application is preferably dialing device agnostic. Thus, the present invention may be used with any number of commercial dialing devices. Such systems may provide for additional functions such as recording calls and maintaining compliance with laws, regulations, and/or internal policies. The user may log in to the web site and then click an icon multiple times until the list of accounts has been completed or until a predetermined maximum number of allowed clicks has been reached. The application may then log the click as well as information on the clicking user as a history comment in the client's system of record and will also send the clicked phone number to a list to be dialed. Additionally, there may be an option for a system administrator to change passwords, track clicks, or otherwise administer the application and its use.

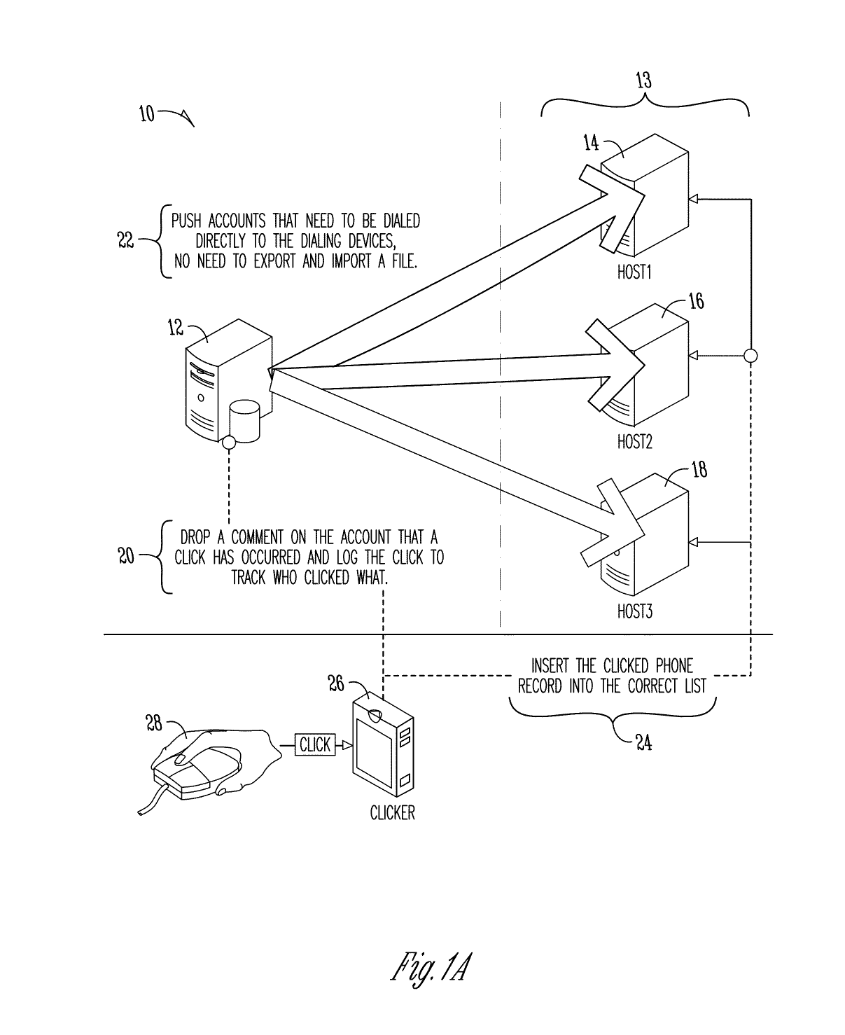

FIG. 1A illustrates one example of a system 10. The system 10 includes a server 12. The server 12 is in operative communication with a dialing device 13 which may include one or more hosts such as a first host 14, a second host 16, and a third host 18. The server 12 and hosts 14, 16, 18 may communicate over a network.

A mouse 28 or other computer hardware device may be used to select a phone number for the list. For purposes here the selection may be in the form of a mouse click which is then communicated to a clicker 26. In response to the selection, in step 24 the clicked phone record may be inserted into the correct list. In addition in step 20 a comment may be entered on the account to indicate that a click has occurred and the click may be logged to indicate which phone record was clicked and which individual performed the clicking. In step 22 accounts that need to be dialed may be dialed without needing to import and/or export a file to do so. Thus, direct dialing is performed where a click is used to initiate a call. Thus, calls made are not a result of any type of random or sequential process but instead may be dialed on direct lines in response to this form of manual intervention.

In addition, it is to be understood that the system 10 may be configured to determine if phone numbers are unauthorized cell phone numbers or not. If phone numbers are unauthorized cell phone numbers, the system 10 may place the unauthorized cell phone numbers in the list of records associated with the clicker 26 and for phone numbers which are not unauthorized cell phone numbers, these phone numbers may be dialed by the dialing device 13 in the conventional manner without manual intervention.

FIG. 1B illustrates a system 30 which includes a manual clicker application or app 32. The manual clicker app 32 may be programming in any number of different computer languages and stored as a series of instructions on a non-transitory computer readable storage media. The manual clicker app 32 may include a user interface 34 which may be a web-based user interface. One of the advantages of a web-based user interface is that it is convenient when implementing the manual clicker app as a cloud-based service or hosted service. The user interface 34 is configured for accessing a database 36. The database 36 may be stored in any number of different formats on a non-transitory computer readable storage medium. For example, the database 36 may be a relational database. The database 36 may be a database running on Microsoft SQL Server. The user interface 34 may access the database 36 in various ways. One such way is through structured query language (SQL) 35. It is to be understood that other types of databases and other types of languages may be used. The database 36 is also shown in operative communication with a dialing device 38. The dialing device 38 may be of any number of types known in the art. SQL Server Integration Services (SSIS) packages 37 may be used for moving data between the database 36 and the dialing device 38.

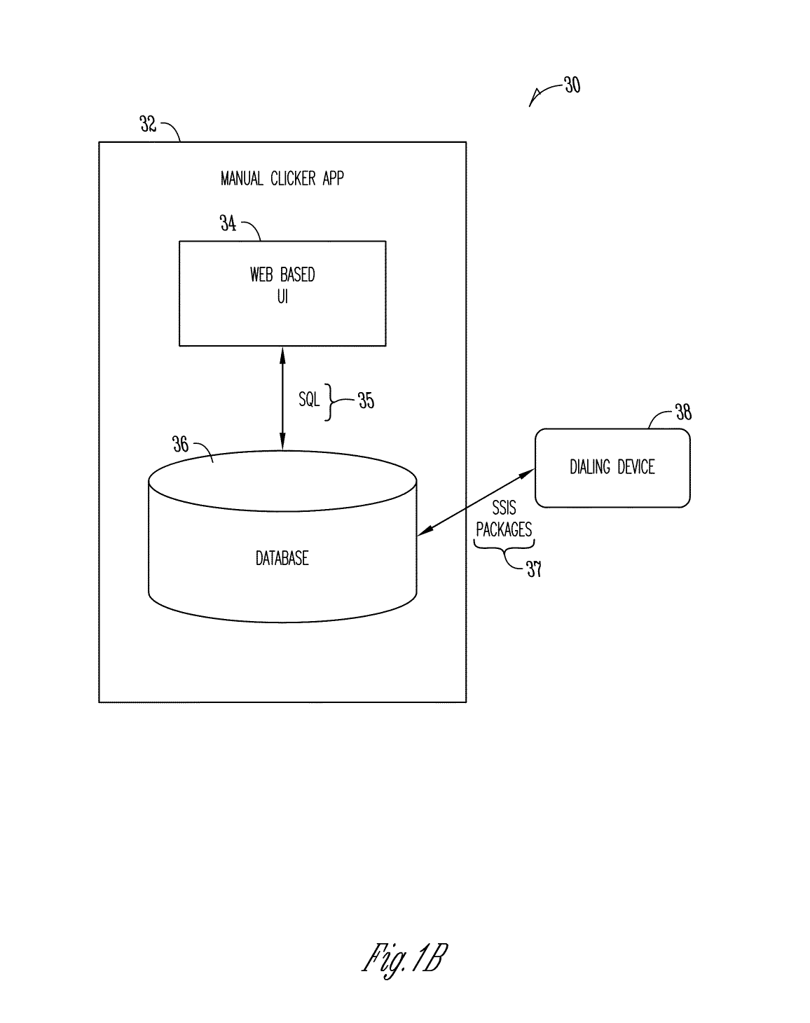

FIG. 2 illustrates a work flow of a user clicking according to a method 40. In step 42 a person logs into the clicker application. In step 44, the user selects a list to click. In step 46, the user clicks display records until all of the records are clicked or the list is full. In step 48 a user may select another list to click.

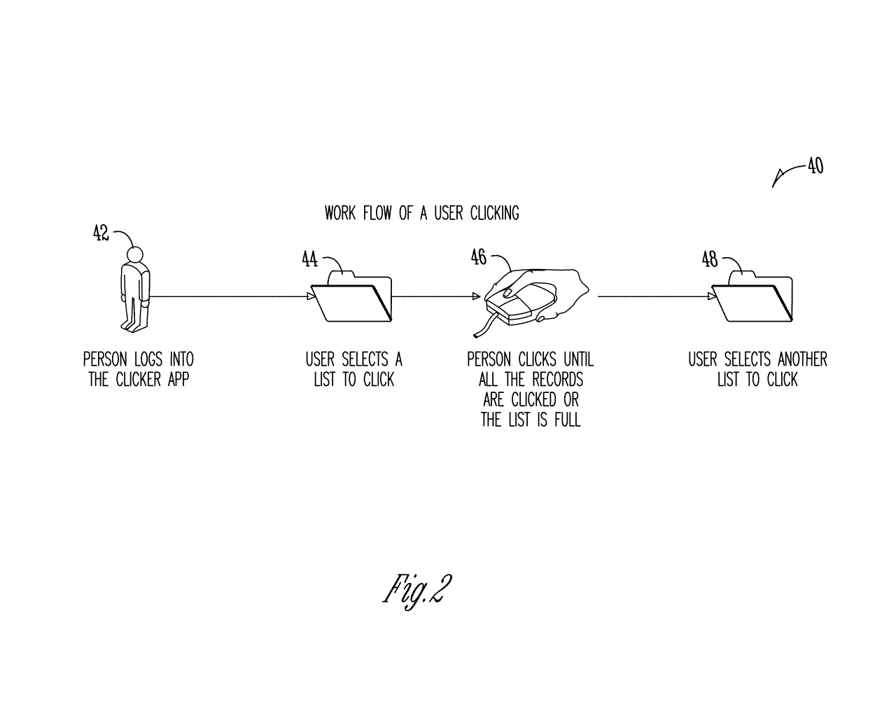

FIG. 3 illustrates another method 60. The method 60 may be performed using a cloud-based service associated with the internet 62. In step 64 a log-in page may be displayed by a user. In step 66 a user may then log into the service. In step 68 a list selection/click page may be presented to the user. In step 70 the user may select a list from available lists. In step 72 a page is loaded which may include a count of the records contained in the list. In step 74 a user clicks or otherwise makes a selection of one of the records from the list. In step 76, a history record may be created on the account that was clicked. In step 78 a phone number may be placed in the list that was selected. In step 80 the click may be logged in the clicker tables to track who has made what clicks. In step 82 the count of remaining phone records in the list is decreased by one.

In step 84 a determination is made as to whether there are any more phone records to click in the list. If there are, then the process returns to step 74 to await the next user click. If there are not then in step 86 a determination is made as to whether or not the refresh button was selected. If it was, then in step 72 the page is loaded again with a new count of records in the list. If not, then in step 88 a user selects a list. In step 90 the process is repeated until there are no more records to be clicked or the maximum number of un-dialed phone numbers is reached. In step 92 the user may log out and in step 94 a log in page may be displayed again.

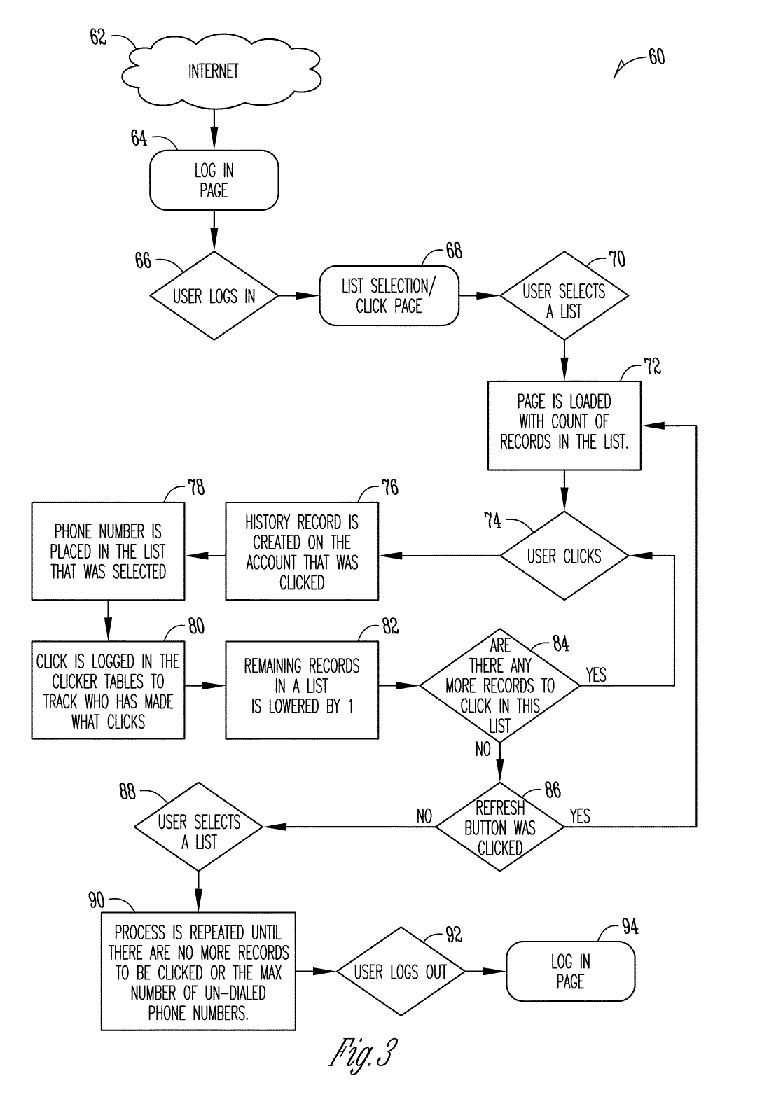

FIG. 4 illustrates one example of a configuration or database schema for a relational database 100 which may be stored on a non-transitory computer readable storage medium. A first table 102, a second table 104, a third table 106, and a fourth table 108 are provided. The first table 102 is a user table. The second table 104 is a status table. The third table 106 is a list table, and the fourth table 108 is a click table. Each table may have various fields. Fields associated with the user table 102 may include an email address of the user, a password of the user, a date/time of their last login, a locked field to indicate whether that user is locked, and administrator field to indicate whether the user is an administrator, and a status identifier. Thus, information about each user and their login may be stored. Fields associated with the status table 104 may include a name and a program value. Fields associated with the list table 106 may include a name, a server name, a database name, a username, a password, a status identifier, a select records field, an agency server field, an agency database field, an agency username, and an agency password. Thus, information regarding each list and attendant information may be maintained. Fields associated with the click table 108 may include a user identifier field, a list identifier field, a time and date of a click, a phone number associated with the click, and an account number associated with the click. Thus information regarding each click of a phone number may be maintained. In addition, each table may have a primary key (PK) and one or more foreign keys (FK1, FK2, FK3).

Although a particular database schema is shown in FIG. 4 it is to be understood that the present invention contemplates any number of variations, alternatives, and changes including additional tables, fewer tables, additional fields, fewer fields, and different keys.

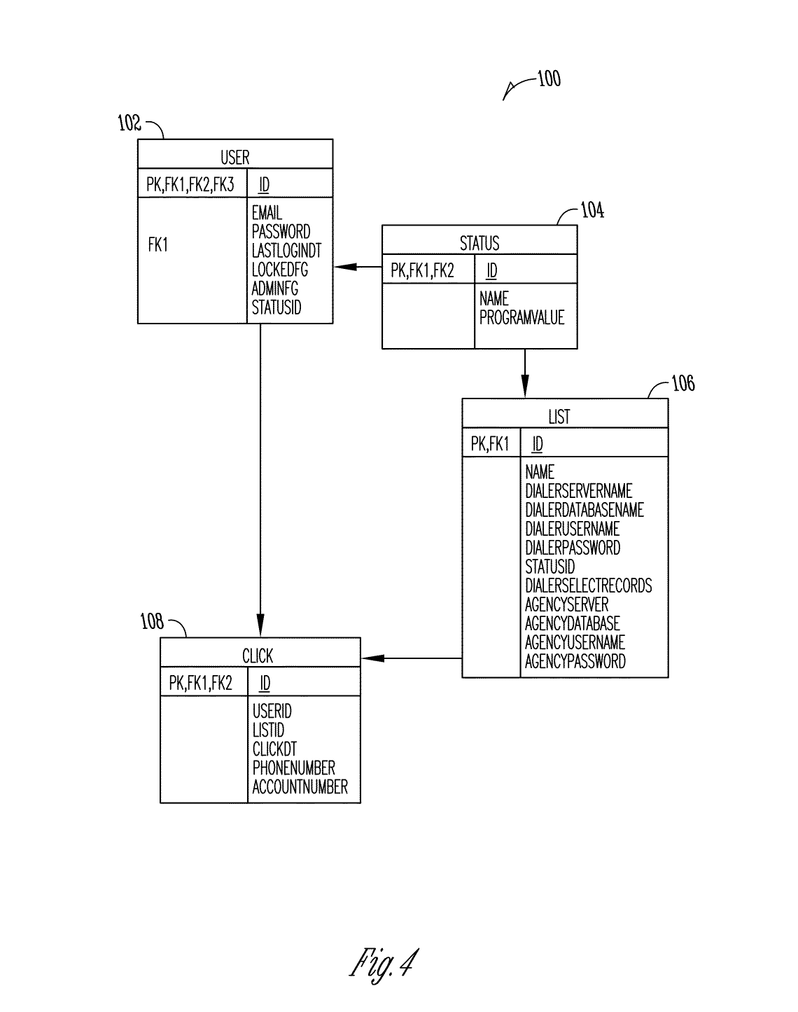

FIG. 5A illustrates a login screen 120. The login screen 120 may include a username input 122 which may accept an email address as a username and a password input 124 as well as a sign-on button 126. The username and password input may match a record in the user table. The date and time of a successful login may be stored as a part of the user table 102 of FIG. 4.

FIG. 5B illustrates a first time login screen. Here, a user may enter a default password as the current password 121. They may then enter a new password 123, re-enter the new password 125, and select a save button 127. Thus, the user may be forced to change their password to a password different than the current password. The present invention contemplates any number of various password controls for improving security. This may include requiring periodic password resets (such as every 90 days), preventing the use of a password previously used within a particular time frame (such as the last 180 dates), requiring that any password meet particular criteria such as containing a certain number of characters, including an uppercase character, including a lowercase character, including a number.

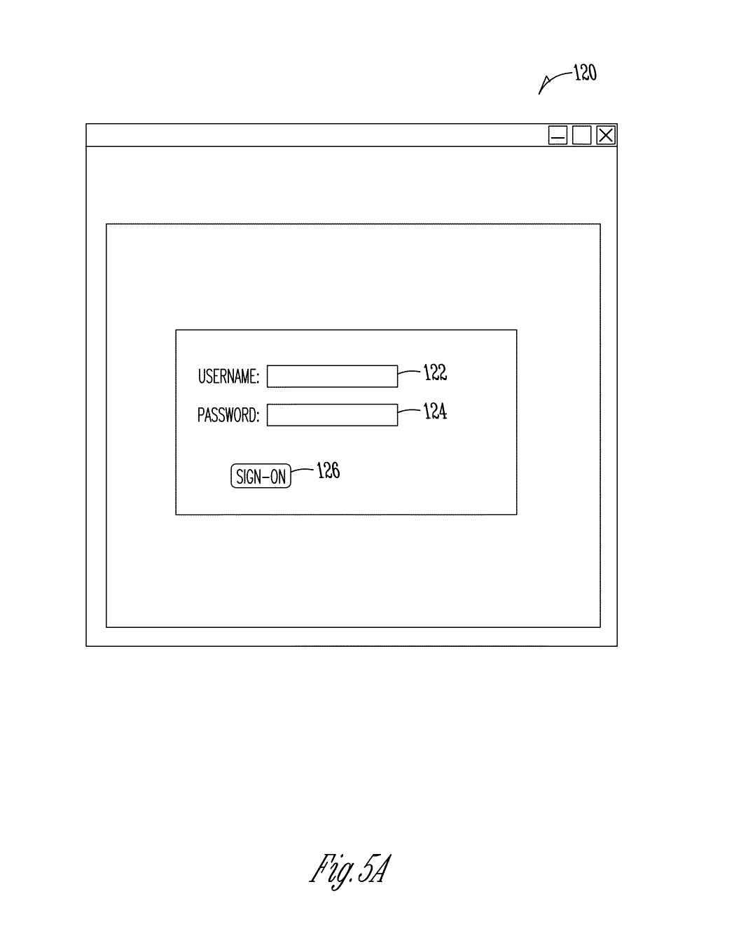

FIG. 6 illustrates a screen display 130 showing a main page. Various user interface elements may include buttons or tabs such as for user maintenance 136 and to logout 138. A current day click total 132 is shown as well as the number of clicks left in the list 134. Note that there are still clicks left in the list. A list selection drop down 146 is shown which allows a user to select a list. Preferably the list is a list of unauthorized cell phone numbers. For each such record in the list, the user must provide a click or other manual intervention before the record may be communicated to a dialing device. The user may click on the icon 142 which may be in the form of a target. The user may do so by positioning the pointer 144 over the icon 142 and pressing a mouse button or other button associated with a user input device. The present invention contemplates that instead of a mouse, numerous types of other user input devices may be used such as a trackball, a rollerball, a joystick, a touch window, a touch screen, a touch pad, a digitizing tablet, mousekeys, keyboard, or other type of input device.

Note that in the preferred embodiment, information associated with each record is not shown. The software application performs the function of associating each of the clicks with a corresponding record in the list, thus displaying such information is not needed. However, it is contemplated that such information could be displayed. In operation, a user may continue to click while waiting to be connected to a phone call or during a phone call. It is also to be understood that the user that performs the clicking need not be the telephone operator but may be a different individual potentially at a different location.

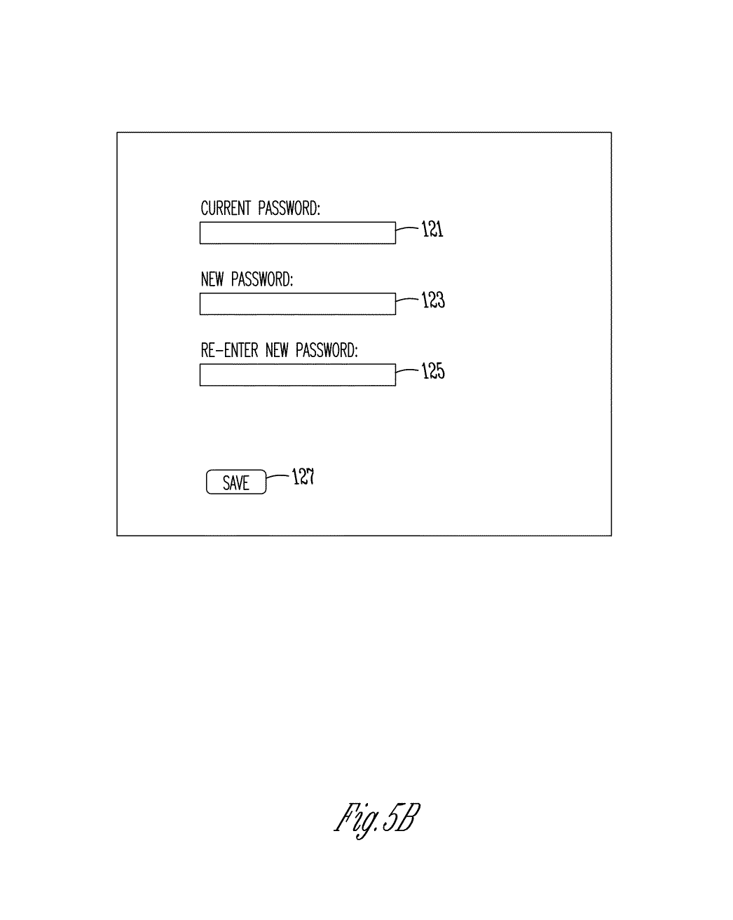

FIG. 7 illustrates a screen display 140 showing a main page where the list selected using the list selection drop down 146 is not available as there are no clicks left in the list. Thus the current day click total 132 is at zero and the number of clicks left in the list 134 is also at zero.

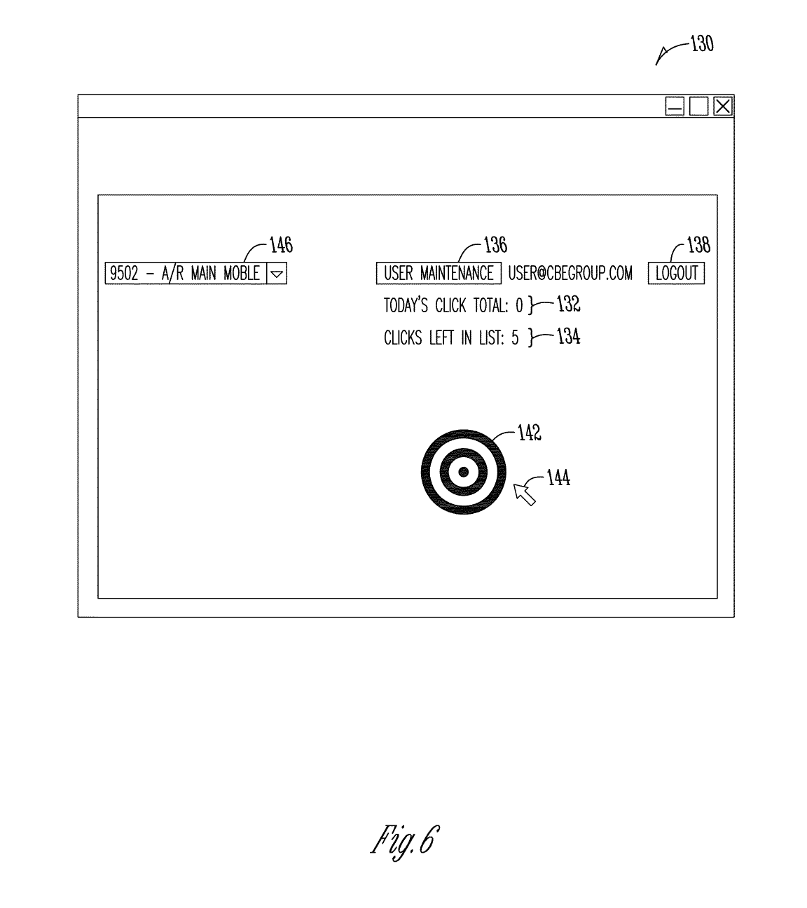

FIG. 8 illustrates a screen display 150 which includes functions associated with a user account such as a part of a user maintenance page used to create a new user account. This includes a new user tab or button 168, a modify user tab or button 166, and a reset password tab or button 152, an email field 154, a password field 156, and account attributes 158 such as to specify if the account is an administrator account or if the account is locked. Status 160 indicates whether the account is active or inactive. A save button 162 may be used to save changes associated with the information. From this page or display a user may select the clicker page 164 tab or button or may select the logout tab or button 138.

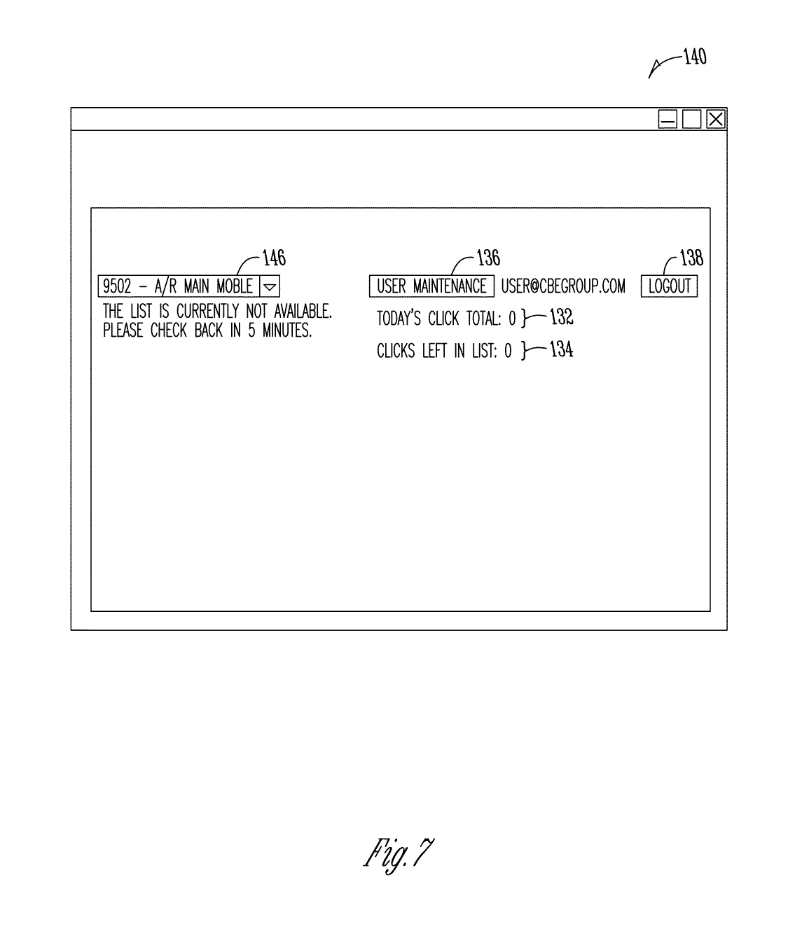

FIG. 9 illustrates a screen display 170 which shows user information associated with a modify existing user page. The user information may include a user 171 and an associated email address 173, the fact that the account is an administrator account 158 and is active 160. In addition, click information 172 is shown in a table with a column for date information 174 and a column for click count 176. A last login date and time 178 is also shown.

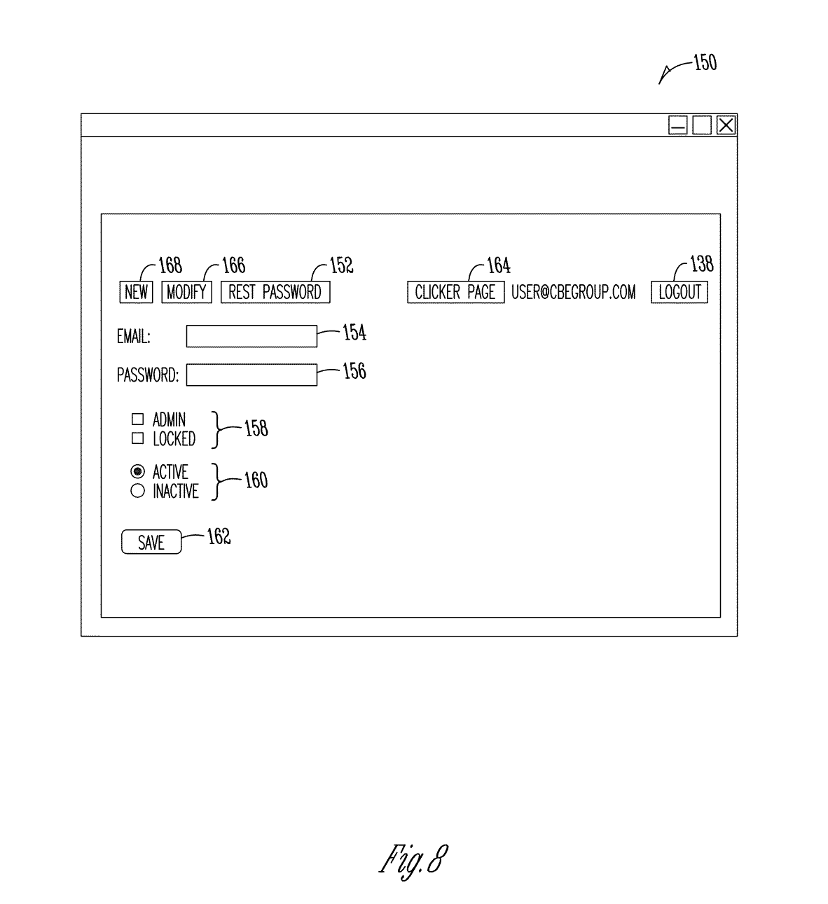

FIG. 10 illustrates a screen display 180 which shows user information which may be used for resetting a password associated with a user such as may be displayed after selecting button or tab 152.

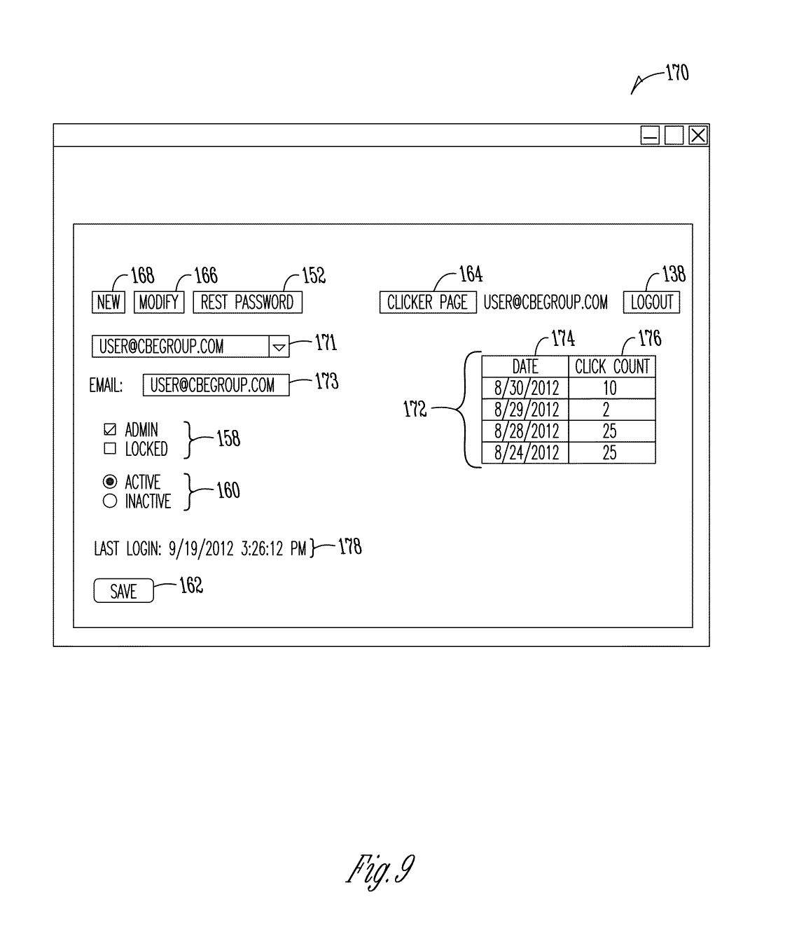

FIG. 11 illustrates another example of a screen display for a manual clicker application clicker page. As shown in FIG. 11, a non-administrator user may interact with the clicker page by selecting a group from the drop down box 147, clicking on the bull's-eye icon 142, or logging out. A daily click total 132 is shown. The daily click total 132 may represent an approximate number of clicks that the user has made within the same day. The number of daily clicks may be updated from the database when the page is reloaded. A clicks left in group 135 is also shown which is used to display the number of clicks available in all lists within a group whenever a group is loaded or the page is refreshed.

Although various features and functions are shown, it is to be understood that numerous other functions are fully contemplated. For example, a penetration counter may also be shown. The penetration counter may be used to measure a user's performance or contribution towards meeting a penetration goal for a particular area. Once the goal has been met, the application may indicate to the user that the goal has been met. Another addition may be to show a start time and hours remaining on the click page. Of course, any number of other features, including display of other types of user metrics or group metrics may be displayed.

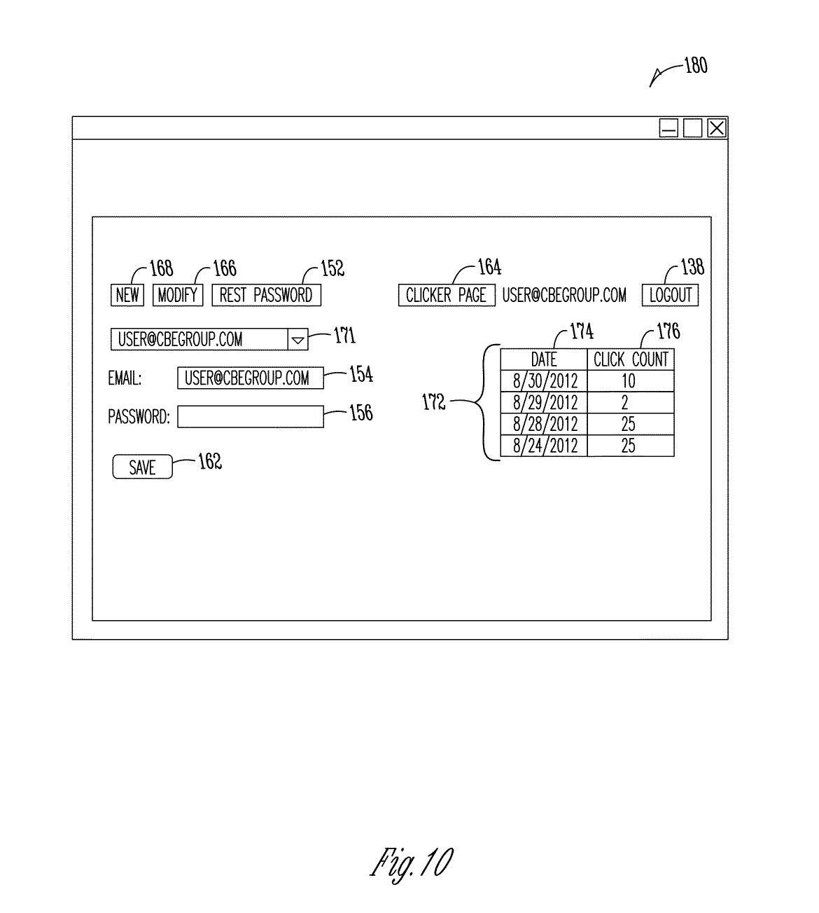

FIG. 12 illustrates one example of a screen display which may be displayed without a bulls eye. This may occur for various reasons. For example, this may occur when all the lists within a group have run out of clicks. This may also appear if there are too many pending calls on the dialer for all the lists in the group. In this case the user will need to wait for some of the numbers to be dialed before they can resume clicking. This may also appear if all the lists in the group are manually turned off. This may also appear if the group does not have any lists assigned to it.

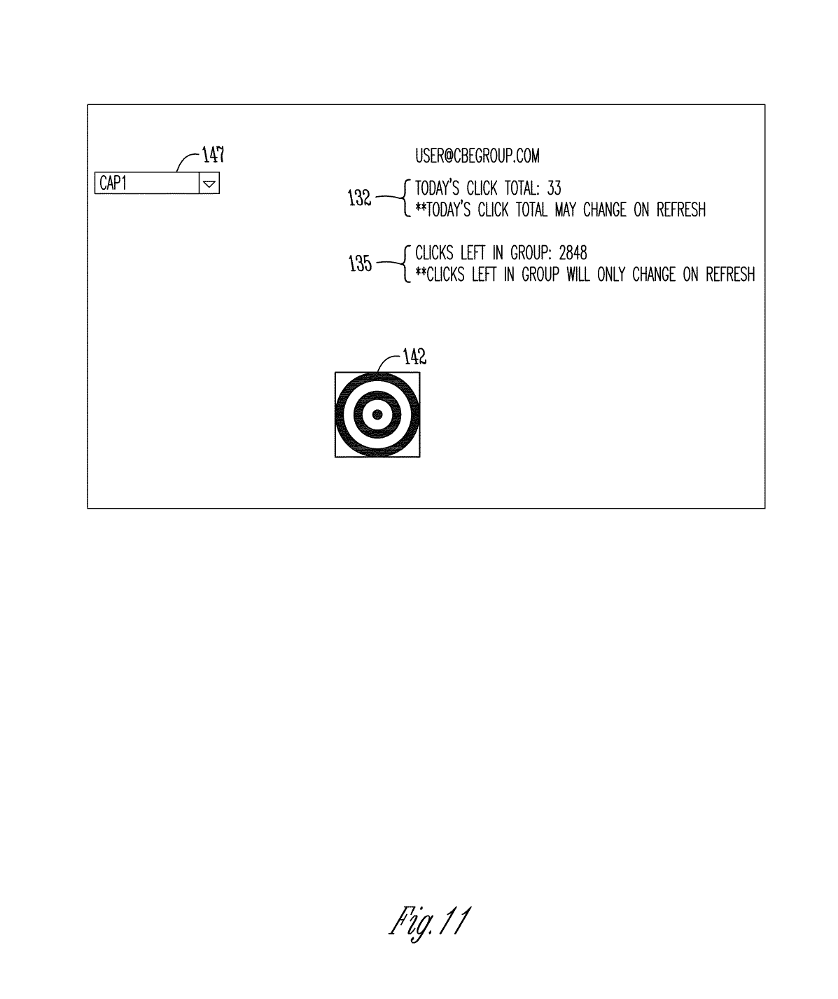

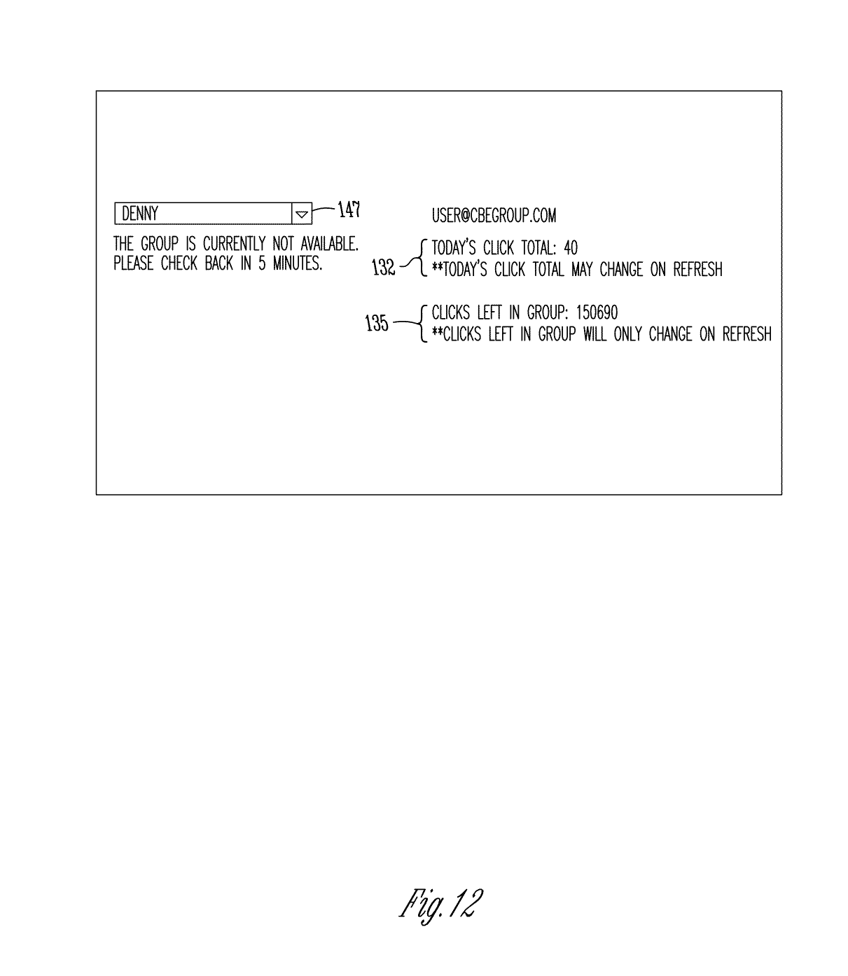

FIG. 13 illustrates a menu bar 200 with various buttons including a home button, a user maintenance button, a list maintenance button, and a logout button. FIG. 14 illustrates a user maintenance page with a navigation bar. The available options include new 168 for adding a user, modify 166 for modifying a user, and reset password 152 for resetting a password.

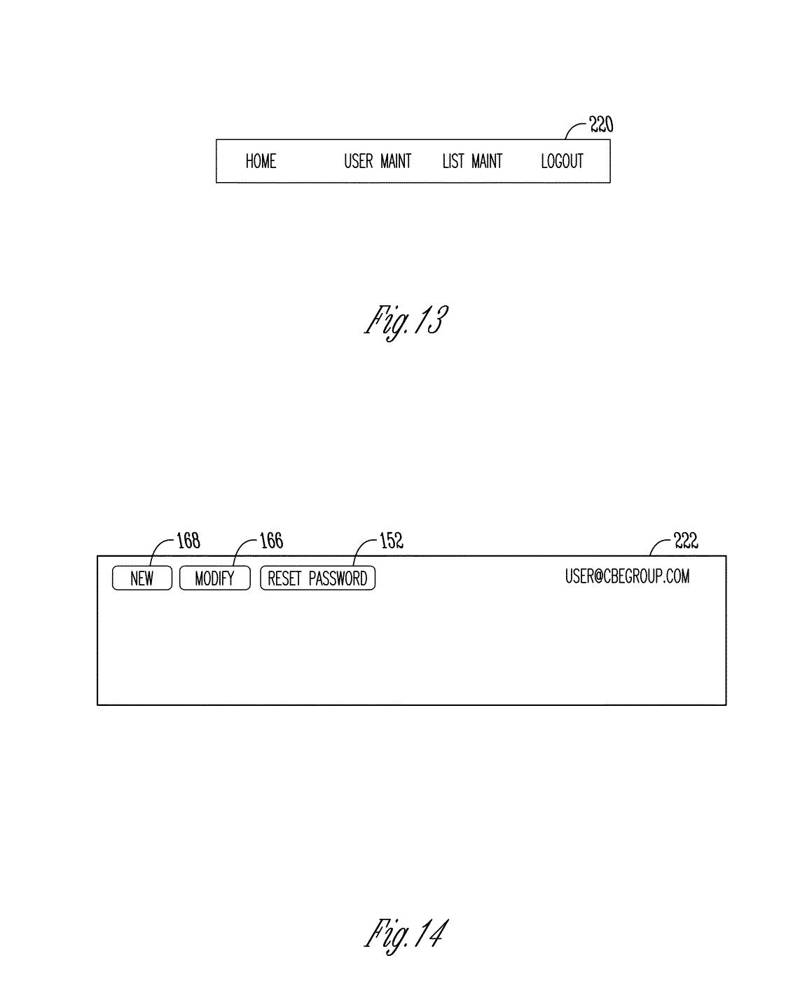

FIG. 15 illustrates an example of a create new user page. The new button 168, modify button 166, and reset password button 152 are shown. A text input box for email 154 and a text input box for a password 156 are shown. It is contemplated that various different types of roles 157 may be assigned to the user. Different rights or privileges may be assigned to the user based on their assigned role. Examples of roles include User Setup Admin, User lock and Reset Admin, List Maintenance Admin, List Schedule Admin. A User Setup Admin role may be used to create and edit users. The User Unlock and Reset Admin role may be used by supervisors and managers to unlock users and reset passwords. This role does not give the ability to edit or view other user's roles. The List Maintenance Admin role may be used for creating and modifying lists and list groups. The List Schedule Admin role may be used for editing the schedule for list groups. When the user is created, whether the account is locked 158, and whether the account active or inactive 160 may also be assigned. A save button 162 is also provided for saving the new user information.

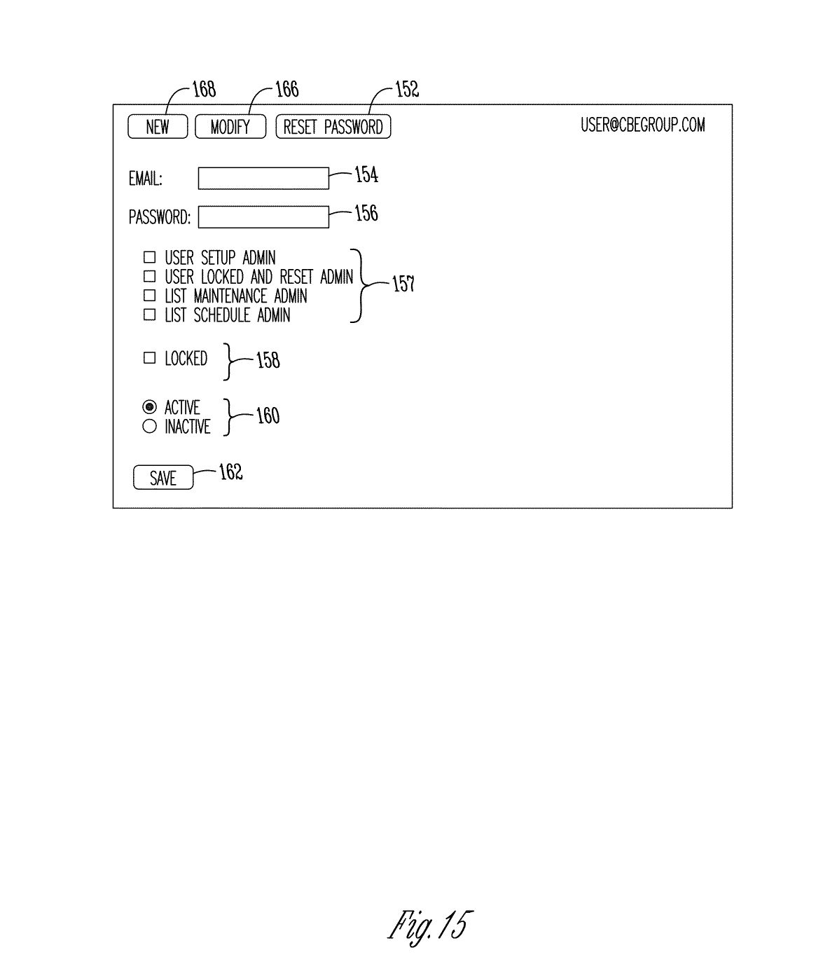

FIG. 16 illustrates a modify an existing user page. As shown in FIG. 16, there is a new button 168, modify button 166, and reset password button 152. A user may be selected from a drop-down list box. The role(s) 157 of the user, whether the user account is locked 158, or active/inactive 160 are also shown. To the right is a table 172 which includes click counts for different dates.

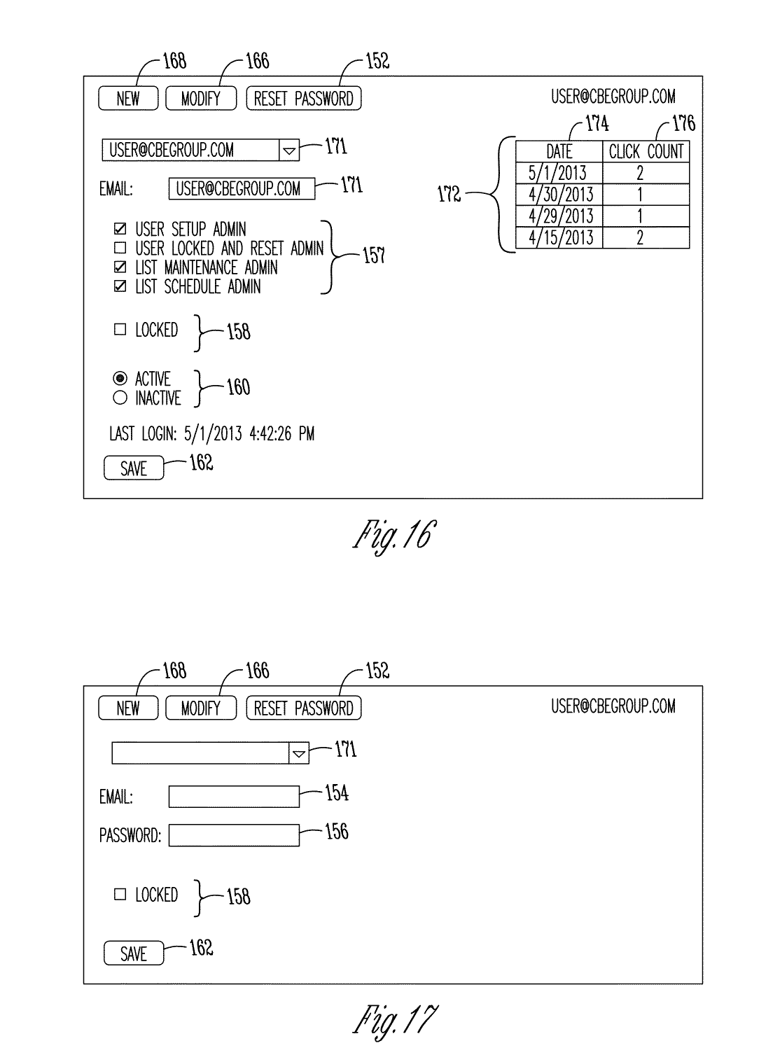

FIG. 17 illustrates a reset a user password page. A user is selected from the drop down list box 171 and a temporary password may be assigned. In addition the locked 158 status may be changed. Thus, for example if the user's account is locked from too many failed login attempts, the account may be unlocked.

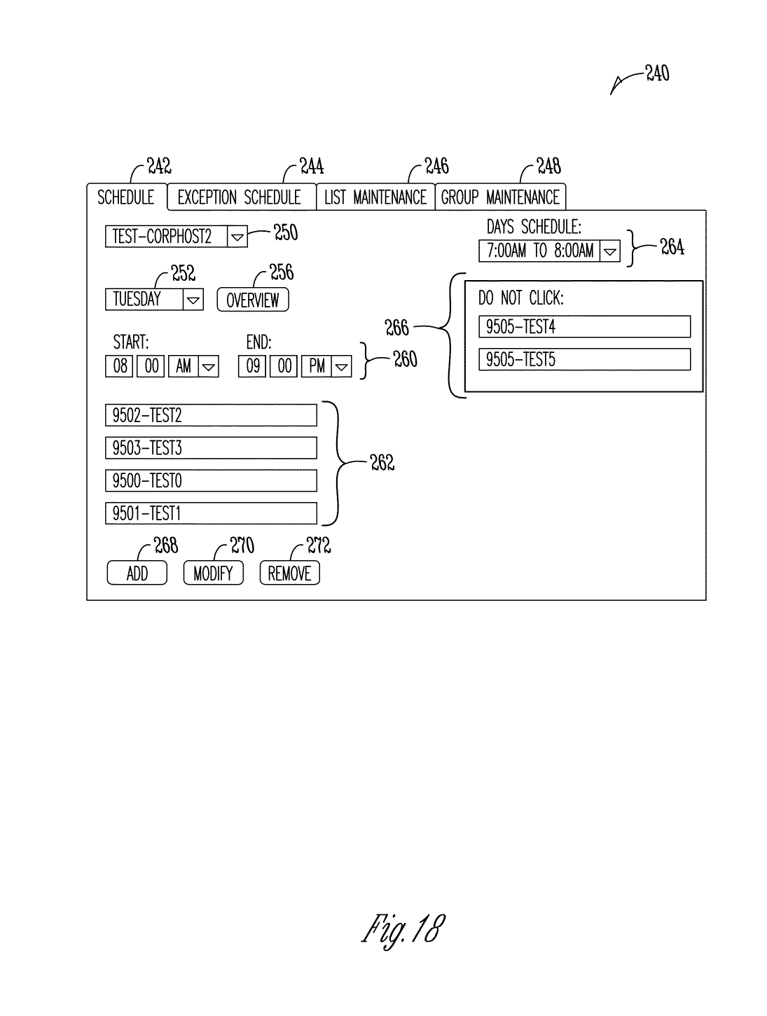

FIG. 18 illustrates a screen display 240 which includes a schedule tab 242. Other tabs across the top of the screen display 240 include an exception schedule tab 244, a list maintenance tab 246, and a group maintenance tab 248. The schedule tab 242 may be used to set default times and priorities for groups. The dropdown list box 250 may be used to select a group. A user can select the overview button 246 to view the current default scheduled for a selected group. Alternatively, the drop down list box 252 may be used to select a day of week. After a day of the week has been selected, the user can select existing scheduled times from the day's schedule to modify or delete, or else the user can enter new start and end times 260 to enter a new schedule for the selected day. List priority may be set by arranging the list to reflect the desired priority within the group 262. If a list is moved to the do not click box 266, that list will not be clicked or otherwise selected for a current schedule. The add button 268 may be selected to add a new schedule and will not allow the schedule if it conflicts with an existing schedule. The modify button 270 may be used for modifying an existing schedule. The remove button 272 may be used for removing an existing schedule.

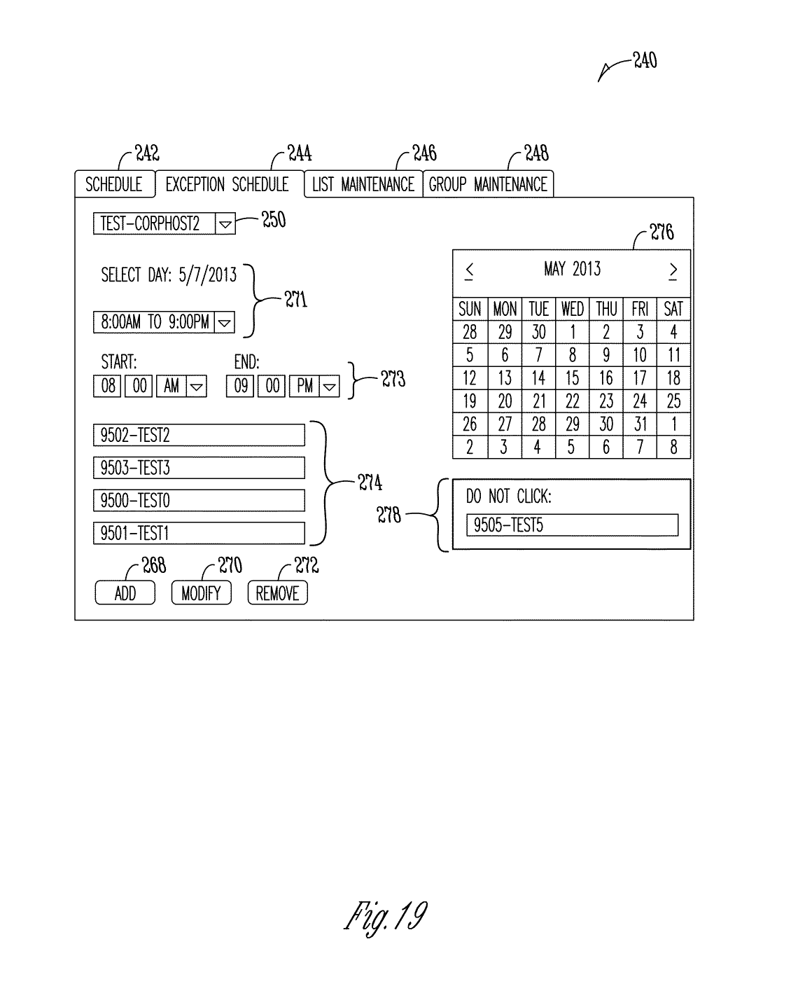

FIG. 19 illustrates the exception schedule tab 244. The exception schedule tab 244 may be used to set the exceptions to the default times and the default list priorities for the groups. To set an exception schedule, a user may select a group from the dropdown list box 250 and a day from the calendar 276. The user may then select existing scheduled times from the list box 271, or may enter a start and end time 273 to a enter a new schedule for the selected day of the week. List priority may be set by arranging the list (such as through dragging and dropping list items) until the order shown reflects the desired priority with the highest priority at the top and the lowest priority at the bottom. If a list is dragged or otherwise moved to the Do Not Click box 278, that list is not a part of the current schedule. The add button 268, modify button 270, and remove button 272 may be used for adding a new schedule, modifying an existing schedule, or removing an existing schedule.

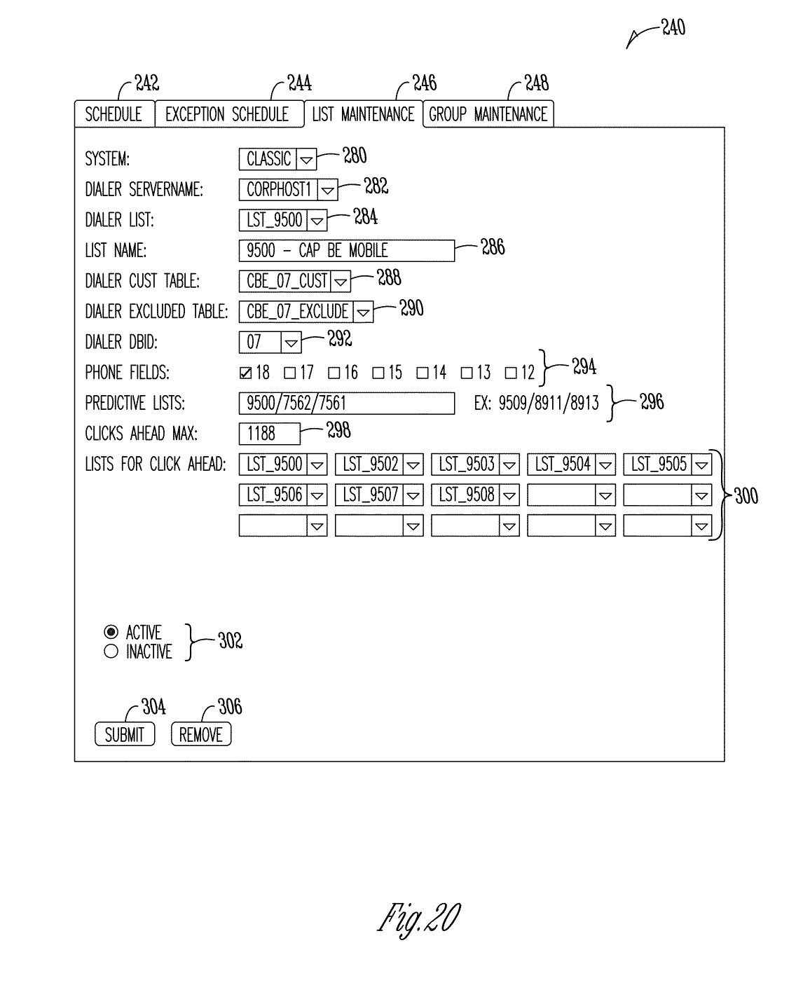

FIG. 20 illustrates the list maintenance tab 246. The list maintenance tab includes functions that allow a user to modify lists. To edit a list, the user may select the system the list is for using the list box 280. The user may select a dialer server name from the list box 282. The dial server is a dialing device which is used for a particular list of records. The user may select a dialer list from the list box 284. The dialer list is a list of records that have been clicked by an individual and will be sent to the dialing device. A list name is shown in text box 286. A dialer customer table may be selected from list box 288, and a dialer exclude table may be selected from the list box 290. All phone numbers reside in the dialer customer table. The function of the dialer customer table is to identify phone types.

A dialer database identifier (DBID) may be entered in the text box 292. The function of the DBID is that when a phone number to be called is sent, the DBID is attached to the record so that the dialing device will know how to document the action to the proper dialer exclude table and the proper dialer customer table. The number of phone fields may be selected from the phone fields selections 294. One or more predictive lists may be entered in the text box 296. A predictive list is a list of all accounts. The cell phone numbers are pulled out of the predictive list so as to avoid the cell phone numbers being dialed predictively in violation of the TCPA.

The number of clicks ahead permitted may be entered in the text box 298. The lists for click ahead may be selected from the group of drop down list boxes 300. In addition active/inactive status 302 may be specified. A submit button 304 is provided to submit the list and a remove button 306 is provided for removing the list.

Although various examples of list maintenance functions are shown, the present invention contemplates numerous other variations. For example, goals may be tracked. For example, penetration goals may be assigned and tracked. In addition, functionality for creating, activating, and disabling lists may be provided to allow someone who is assigned a list maintenance role to create new lists and then activate or disable them as needed. Functionality for creating groups and assigning lists to a group may be provided. Here the group may be a group of associates who would receive the calls.

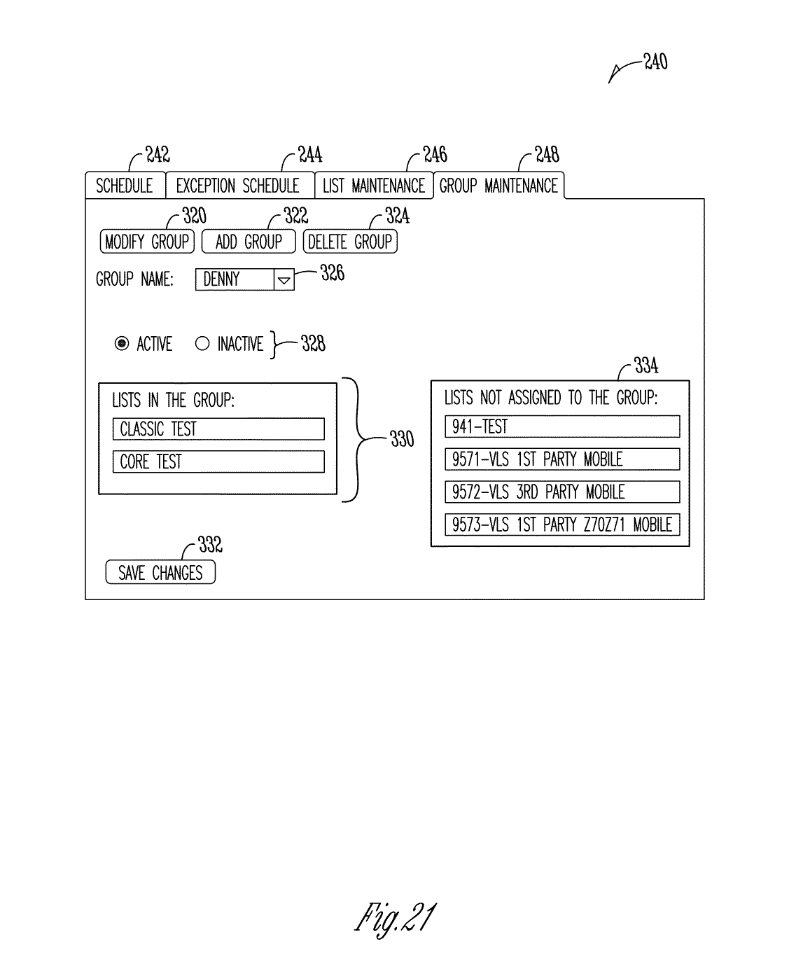

FIG. 21 illustrates the group maintenance tab 248 which may be used to edit, create or delete groups. A modify group button 320, add group button 322, and delete group button 324 are shown. A group may be selected from the drop down list box 326. An active/inactive status 328 is associated with the group. One or more lists from the lists not assigned to a group box 334 may be moved to the lists in the group box 330.

The present invention contemplates that a reporting component may be used as a part of the application to provide various reports. For example, a report maintenance page may be used to report information such as penetration within a particular area, metrics regarding a particular user, list, or group, a click history, performance by schedule, a settings history, or to otherwise compile, collate, calculate, or report on performance in any manner.

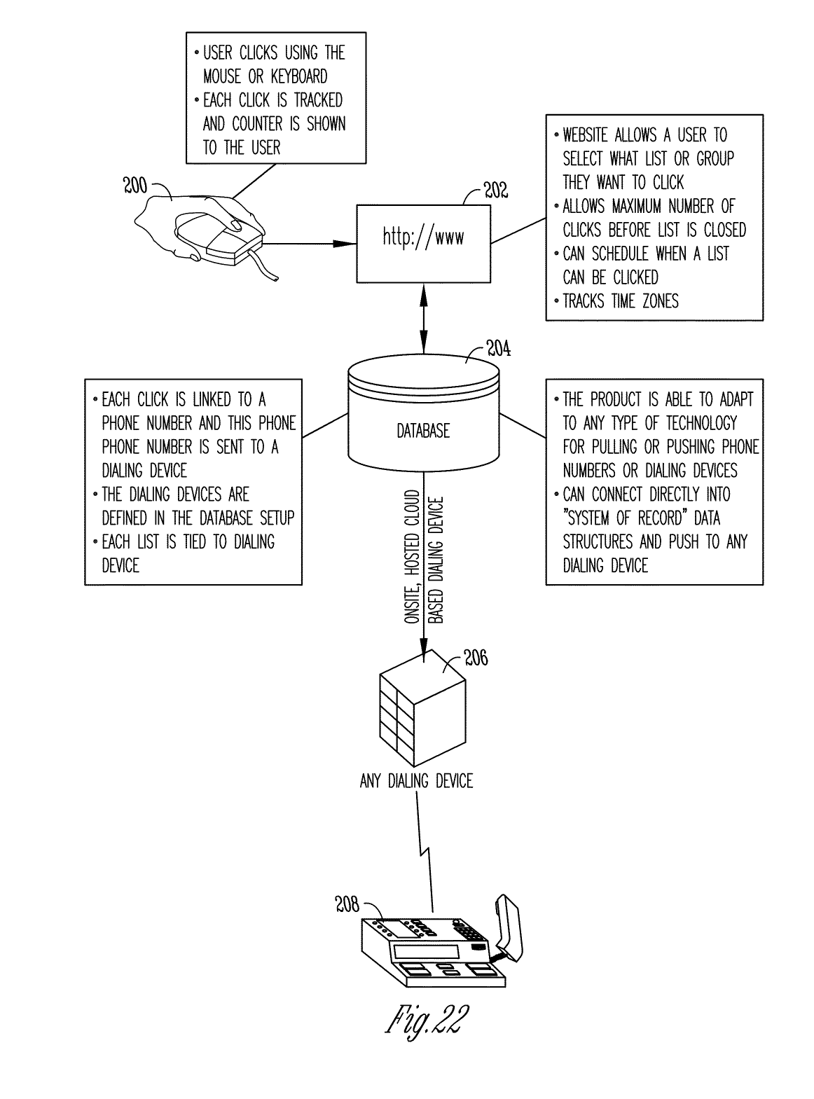

FIG. 22 illustrates another overview. In step 200 a user performs an operation such as a selection operation such as a click with a mouse or keyboard. Each click is tracked and feedback is displayed to the user such as via a counter to show the number of clicks in a given time period. In step 202, a web site allows a user to select what list or group that the user wants to click. A maximum number of clicks are allowed before the list is closed. The time period during which a list can be clicked may be scheduled; the scheduling may take into account different time zones.

A database 204 is shown. Each click may be linked to a phone number and the phone number is sent to a dialing device. Each dialing device may be defined in the database setup. Each list may be tied to a dialing device. Any number of different types of technologies may be used for pulling or pushing phone numbers any number of different types of technologies may be used for dialing devices. In one embodiment software allows for connecting directly into “systems of record” data structures and pushing to any dialing device.

A dialing device 206 is shown which is in operative communication with the database 204. The dialing device 206 may be located at the same site as the database 204. Alternatively, the dialing device may be made available as a part of a hosted or cloud-based service, thus the dialing device 206 may be located remotely from the database 204. A phone 208 is shown which is operatively connected to the dialing device 206 so that once dialed and/or connected a phone call may be transferred to the phone 208.

As previously explained, a record of every click that takes place may be stored. One way to store information is in a table. For example, the below Click Table may be used to record each click that takes place. Note that stored information may include an identifier for each click, a user identifier for the user making the click, a list identifier to identify a list in which a record is contained, the date and time that the click was made, a phone number associated with the click, an account number associated with the click, and other information such as a minute adjustment, an export status identifier, and an export date and time.

Click Table

| Field Name | Field Type | Keys | Allows Nulls |
|---|---|---|---|
| ID | INT | Primary Key | No |
| UserID | INT | User.ID | No |
| ListID | INT | List.ID | No |
| ClickDt | DateTime | | Yes |
| PhoneNumber | VarChar(75) | | Yes |
| AccountNumber | VarChar(50) | | Yes |
| MinuteAdjustment | INT | | Yes |
| ExportStatusID | INT | ExportStatus.ID | No |
| ExportDt | DateTime | | Yes |

The above Click Table is a record of every “click” that takes place in the Manual Clicker App. This is where the SSIS Export package grabs phone numbers from the Manual Clicker App and places them onto the dialing device. The Export status shows what stage of an export the phone number is in and prevents a number from being sent to the dialing device twice. The numbers may be moved into the click table from the dialer table during the export process. It should be understood that the click table described above is merely one structure that may be used to store information about a click. Numerous other structures are contemplated.

Although various embodiments are shown or described herein, the present invention contemplates numerous variations, options, and alternatives as may be appropriate for a particular implementation or use within a particular environment. For example, the present invention contemplates variations in which clicks are performed, whether the user performing the clicks is the phone operator or not, the type of dialing devices which may be used in conjunction with the manual clicker application, variations in the user interface, and other variations, options, and alternatives.

What is claimed is:

1. A method for manual intervention in a dialing process, the method comprising:
(a) maintaining a list of records containing phone numbers in a database stored on a non-transitory computer readable storage medium;
(b) providing a user interface in operative communication with the database, wherein the user interface is configured to present a user with a target for clicking;
(c) receiving at a computer and from a user using the user interface, a click on the target for each of a plurality of individual records within the one or more lists of records in the database stored on the non-transitory computer readable storage medium;
(d) storing within the database and on the non-transitory computer readable storage medium a record of the click for each of the plurality of individual records, an identity of the user performing the click for each of the plurality of individual records, and an association between the click and a corresponding record for each of the plurality of records; and
(e) for each click electronically communicating the corresponding phone number of one of the records within the one or more lists to a dialing device for dialing the phone number.

2. The method of claim 1 wherein the user interface provides for receiving multiple clicks and queuing each of the associated individual records for dialing.

3. The method of claim 2 wherein the multiple clicks are limited to a maximum clicks ahead constraint.

4. The method of claim 2 wherein the user interface provides for assigning a plurality of different access rights to different users.

5. The method of claim 4 wherein a user assigned administrator access rights is provided access to modify the one or more lists.

6. The method of claim 5 wherein the user assigned administrator access rights is further provided access to schedule the one or more lists.

7. The method of claim 1 further comprising dialing the phone number using the dialing device.

8. The method of claim 1 wherein the user interface includes an icon and wherein the icon is the target of the click for each of the plurality of individual records within the one or more lists of records.

9. The method of claim 8 wherein the click is performed by positioning a mouse pointer on the icon and depressing a button of a mouse.

10. The method of claim 9 wherein the phone numbers are phone numbers for unauthorized cell phones.

11. The method of claim 1 further comprising determining if phone numbers are unauthorized cell phone numbers, for phone numbers which are unauthorized cell phone numbers, placing the phone numbers in one or more of the list of records containing the phone numbers, and for phone numbers which are not unauthorized cell phone numbers sending the phone numbers directly to the dialing device.

12. The method of claim 1 further comprising providing a cloud-based service and providing a manual clicker application to the user through the cloud-based server wherein the cloud-based service provides for performing steps (a)-(e).

13. The method of claim 1 further comprising displaying to a user through the user interface a number of clicks performed within the one or more lists.

14. The method of claim 13 further comprising displaying to a user through the user interface a number of clicks remaining to be performed with the one or more lists.

15. A method for providing a cloud-based service to provide for manual intervention in a dialing process, the method comprising:
maintaining a list of records containing unauthorized phone numbers in a database stored on a non-transitory computer readable storage medium;
providing access to a manual clicker application through a server configured to access the database;
providing a user interface to a user of the manual clicker application, the user interface configured to receive clicks from a user;
receiving a plurality of clicks from the user targeted at an icon of the user interface;
storing within the database a record of each of the plurality of clicks from the user and associating each of the plurality of clicks from the user with one of the records and a corresponding unauthorized phone number;
electronically communicating to a dialing device each of the corresponding unauthorized phone numbers after storing the record of each click.

16. The method of claim 15 further comprising dialing each of the corresponding unauthorized phone numbers using the dialing device.

17. The method of claim 15 wherein the clicks are performed by a user using a mouse.

18. The method of claim 15 further comprising displaying to a user through the user interface a number of clicks performed with the list of records.

19. The method of claim 18 further comprising displaying to a user through the user interface a number of clicks remaining to be performed with the list of records.

20. The method of claim 15 further comprising notifying the user when there has been a click for every one of the records in the list of records.

21. The method of claim 15 further comprising receiving a selection of the list by the user through the user interface.

22. The method of claim 15 further comprising determining if phone numbers are unauthorized cell phone numbers, for phone numbers which are unauthorized cell phone numbers, placing the unauthorized cell phone numbers in the list of records and for phone numbers which are not unauthorized cell phone numbers sending the phone numbers directly to the dialing device.
